(19) United States
(12) Patent Application Publication
(10) Pub. No.: US 2006/0009264 A1
(43) Pub. Date: Jan. 12, 2006

(54) Method for voice dialing of telephone number

(75) Inventors: Jeong-Wook Seo, Daegu (KR); Seung-Nyung Chung, Seoul (KR); Myung-Hyun Yoo, Seongnam-si (KR); Joon-Ah Park, Seoul (KR); Kee-Eung Kim, Seoul (KR); Ji-Hye Chung, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/156,563

(22) Filed: Jun. 21, 2005

(30) Foreign Application Priority Data
Jun. 21, 2004 (KR) 45955/2004

(51) Int. Cl. H04B 1/38

(52) U.S. Cl. 455/563

(57) ABSTRACT

Disclosed is a method for voice-activated dialing of a telephone number on a mobile terminal, which comprises the steps of when voice dialing is selected, entering an initial voice input mode to display a voice dialing section consisting of a plurality of consecutive digit input sections; displaying consecutive digits inputted by voice on the plurality of input sections of the voice dialing section in the initial voice input mode; and when a send key is inputted, making an outgoing call to a telephone number consisting of the digits displayed on the voice dialing section.

### PRIORITY

This application claims the benefit under 35 U.S.C. §119(a) of an application entitled “Method for Voice Dialing of Telephone Number” filed with the Korean Intellectual Property Office on Jun. 21, 2004 and assigned Serial No. 2004-45955, the entire contents of which are hereby incorporated by reference.

### BACKGROUND OF THE INVENTION

1. Field of the Invention

The present invention relates to a method for dialing a telephone number on a mobile terminal. More particularly, the present invention relates to a method for voice-activated dialing of a telephone number on a mobile terminal.

2. Description of the Related Art

Voice recognition is a technology for recognizing or understanding the human voice via computer analysis. Since the human voice has peculiar frequencies depending on the shape of the mouth and tongue position, which change according to pronunciation, it can be recognized by converting speech into an electrical signal and extracting a frequency characteristic of a speech signal. Voice recognition technology is now used in a wide range of applications, such as toys, language learning or consumer electronic devices and home appliances. Dialing on a mobile terminal by voice recognition can eliminate the need to directly input a telephone number by pressing keys and can thereby the enhance user-friendliness of the mobile terminal.

### SUMMARY OF THE INVENTION

Accordingly, the present invention has been made to solve the problems occurring in the prior art, such as having to press keys to input a telephone number, and an object of the present invention is to provide a method for voice-activated dialing of a telephone number on a mobile terminal.

In order to accomplish the above object of the present invention, there is provided a method for voice-activated dialing of a telephone number on a mobile terminal, which comprises the steps of, when voice dialing is selected, entering an initial voice input mode to display a voice dialing section consisting of a plurality of consecutive digit input sections; displaying consecutive digits input by voice on the plurality of input sections in the initial voice input mode; and, when a send key is input, making an outgoing call to a telephone number consisting of the digits displayed on the voice dialing section.

In accordance with another aspect of the present invention, there is provided a method for voice-activated dialing of a telephone number on a mobile terminal, which comprises the steps of, when voice dialing is selected, entering an initial voice input mode to display a voice dialing section consisting of a first to a third input sections for voice dialing; displaying consecutive digits input by voice on the input sections in the initial voice input mode; and, when a send key is input, making an outgoing call to a telephone number consisting of the digits displayed on the voice dialing section.

In accordance with still another aspect of the present invention, there is provided a method for voice-activated dialing of a telephone number on a mobile terminal, which comprises the steps of, when voice dialing is selected, entering an initial voice input mode to display a voice dialing section consisting of a first to third input sections for voice dialing; displaying consecutive digits input by voice on the first input section in the initial voice input mode; selecting any incorrect one of the digits displayed in the first input section and correcting the selected digit; upon completion of the input of digits in the first input section, moving a cursor to the second input section; displaying consecutive digits inputted by voice on the second input section; moving the cursor to select any incorrect one of the digits displayed on the first and second input sections and correcting the selected digit; upon completion of the input of digits in the second input section, moving the cursor to the third input section; displaying consecutive digits input by voice on the third input section; moving the cursor to select any incorrect one of the digits displayed on the first to third input sections and correcting the selected digit; and upon completion of the input of digits in the third input section, making an outgoing call to a telephone number consisting of the digits displayed on the voice dialing section.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a mobile terminal according to an embodiment of the present invention;

FIG. 2 is a flow chart showing a process of inputting digits in a first input section in a voice dialing mode of a mobile terminal according to an embodiment of the present invention;

FIG. 3 is a flow chart showing a process of inputting digits in a second input section in a voice dialing mode of a mobile terminal according to an embodiment of the present invention;

FIG. 4 is a flow chart showing a process of inputting digits in a third input section in a voice dialing mode of a mobile terminal according to an embodiment of the present invention;

FIG. 5 is a flow chart showing a process of making an outgoing call in a voice dialing mode of a mobile terminal according to an embodiment of the present invention; and

FIGS. 6A to 6D are views for explaining the processes shown in FIGS. 2 through 5.

Throughout the drawings, it should be understood that like reference numbers refer to like features, structures and elements.

### DETAILED DESCRIPTION OF EXEMPLARY EMBODIMENTS

Hereinafter, the preferred embodiments of the present invention will be described with reference to the accompanying drawings. In the following description of the present invention, a detailed description of well-known functions and configurations incorporated herein will be omitted for the sake of clarity and conciseness.

A voice dialing section for inputting a telephone number by voice consists of a plurality of input sections. The number of digits in the input sections may vary depending on each country's telephone numbering system. For example, some European countries have a telephone numbering system using four codes, each code consisting of two digits. For use in those countries, mobile terminals should be configured to display four input sections. In certain areas of the United States, telephone numbers consist of three codes (a first code consisting of three digits, a second code consisting of three digits and a third code consisting of four digits). In the Republic of Korea, telephone numbers consist of three codes with three digits, three or four digits and four digits, respectively.

In an embodiment of the present invention, it is supposed that a voice dialing section consists of three input sections to conform to a three-code telephone numbering system as adopted in the Republic of Korea. However, embodiments of the present invention are equally applicable to a voice dialing section with multiple input sections for voice dialing in the European countries, the U.S. and other countries having different telephone numbering systems. The multiple input sections are assigned to display respective codes of a telephone number, such as an area code, a city code, a service provider identification code and a user's calling code.

Also, embodiments of the present invention are equally applicable to all eneral mobile terminals with or without a camera or a TV receiver.

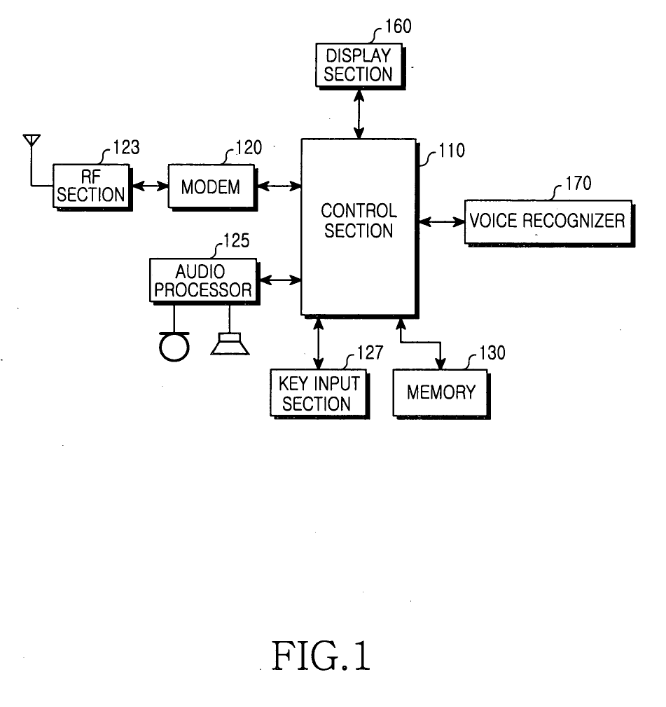

FIG. 1 shows the construction of a mobile terminal according to an embodiment of the present invention.

Referring to FIG. 1, an RF section 123 performs a wireless communication function of the mobile terminal. The RF section 123 comprises a RF transmitter for performing upward conversion and amplification of the frequency of a transmitted signal and an RF receiver for amplifying a received signal with low noise and for performing a downward conversion of the frequency of the signal.

A modem 120 comprises a transmitter for coding and modulating a transmitted signal and a receiver for demodulating and decoding a received signal. An audio processor 125 may comprise a codec which comprises a data codec for processing packet data and an audio codec for processing an audio signal such as a speech signal. The audio processor 125 converts a digital audio signal outputted from the modem 120 into an analog signal through the audio codec and reproduces the analog signal. Also, the audio processor 125 converts an analog audio signal generated from a microphone into a digital audio signal and transmits the digital audio signal to the modem 120. The codec can be provided as an independent element or included in a control section 110.

A memory 130 may be composed of a program memory and a data memory. The program memory comprises programs for controlling the general operations of the mobile terminal and the programs for recognizing a telephone number inputted by voice and displaying the recognized telephone number according to embodiments of the present invention. The data memory temporarily stores data generated during the implementation of the above programs. The memory 130 can store a telephone code table with specific code numbers, such as area codes and service provider identification codes. The memory 130 can also store a phonebook with telephone numbers. The control section 110 can search a phonebook stored in a network database, as well as telephone numbers stored in the memory 130.

The control section 110 controls the overall operations of the mobile terminal. The control section 110 can include the modem 120 and the codec. According to embodiments of the present invention, the control section 110 recognizes digits input by voice in the voice dialing mode through a voice recognizer 170 and displays the recognized digits in the first to third input sections of the voice dialing section. Also, the control section 110 controls the correction of any digit incorrectly input and displayed in the voice dialing section. The control section 110 determines which type of correction should be made according to the user's input. The control section 110 recognizes the input of a specific function key, a specific icon or an user's voice command as the user's input. The control section 110 determines the type of correction according to the length of time during which a specific function key or a specific icon is input or to the user's voice command, and controls the correction of the digit. In addition, the control section 110 controls an outgoing call to the telephone number displayed in the voice dialing section.

A display section 160 displays the user data output from the control section 110. When using an LCD, the display section 160 can comprise an LCD controller, a memory for storing image data and an LCD device. When the LCD is a touch screen, it can also serve as an input section. The display section 160 also displays the voice dialing section consisting of the first to third input sections in the voice dialing mode according to an embodiment of the present invention.

A key input section 127 is provided with keys for inputting numbers and characters and function keys for setting up various functions. The key input section 127 can also include a function key for voice dialing according to the present invention.

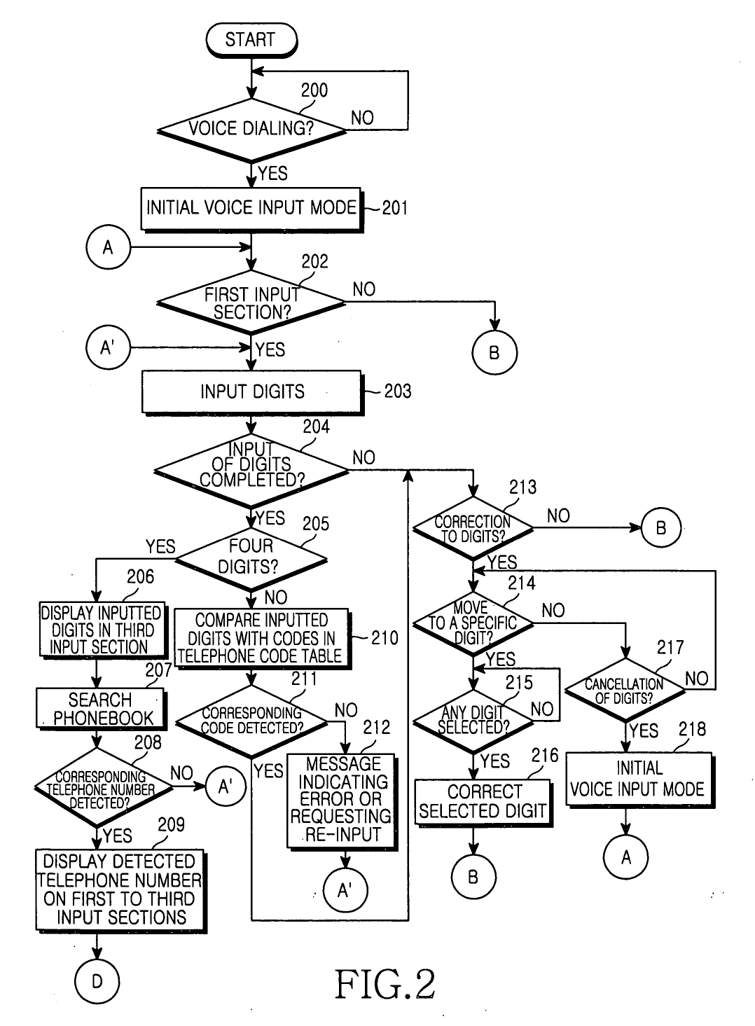

When a sound made by the user is inputted through a microphone, the voice recognizer 170 detects the start and end points of the sound. Upon extracting characteristic data in a speech section excluding mutes preceding and following the speech, the voice recognizer 170 performs vector quantization on the data in realtime. The voice recognizer 170 detects a word most similar to the characteristic data from the words recorded in a database. The voice recognizer 170 converts the detected word into a character signal which is then displayed on the voice dialing section of the display section 160. The voice dialing operation of the mobile terminal will be explained in more detail with reference to FIGS. 2 through 6.

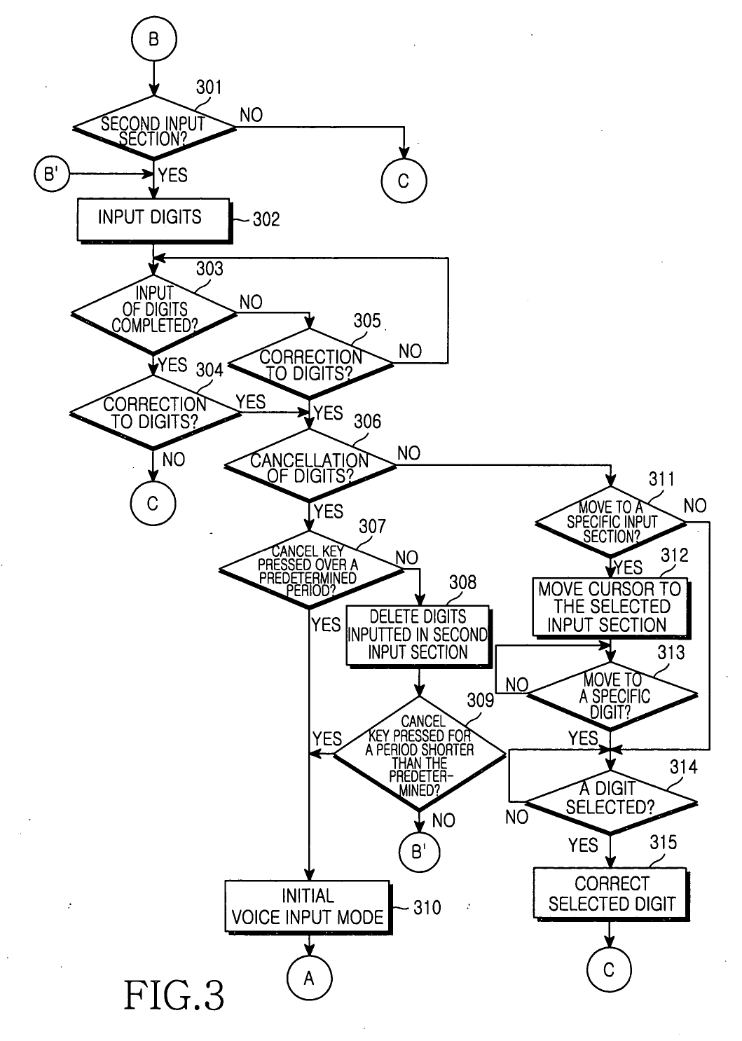

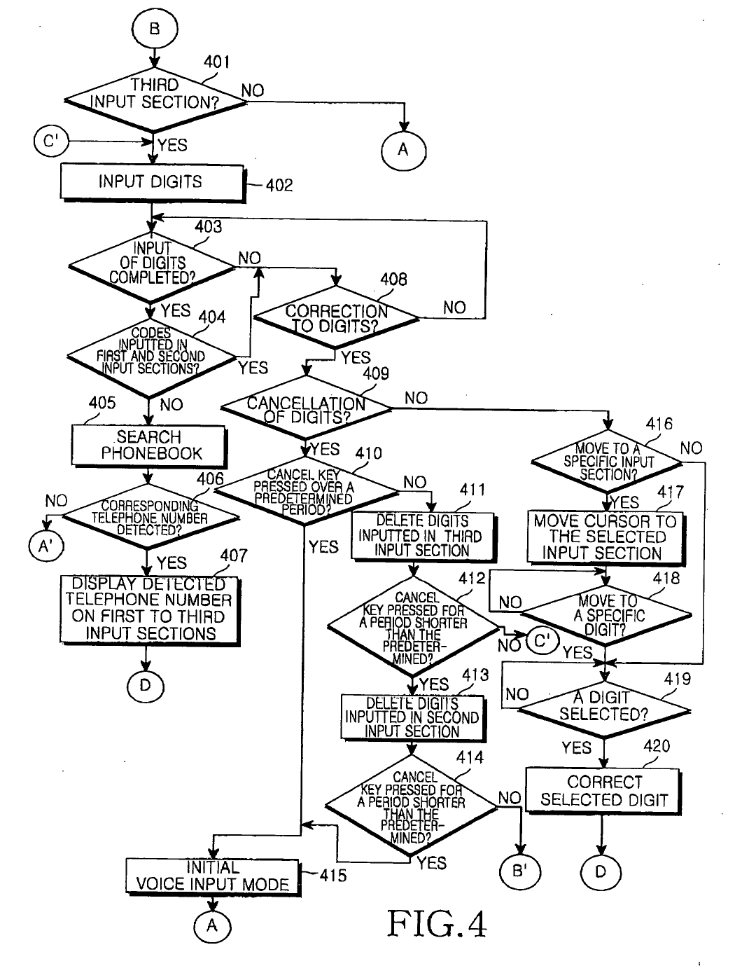

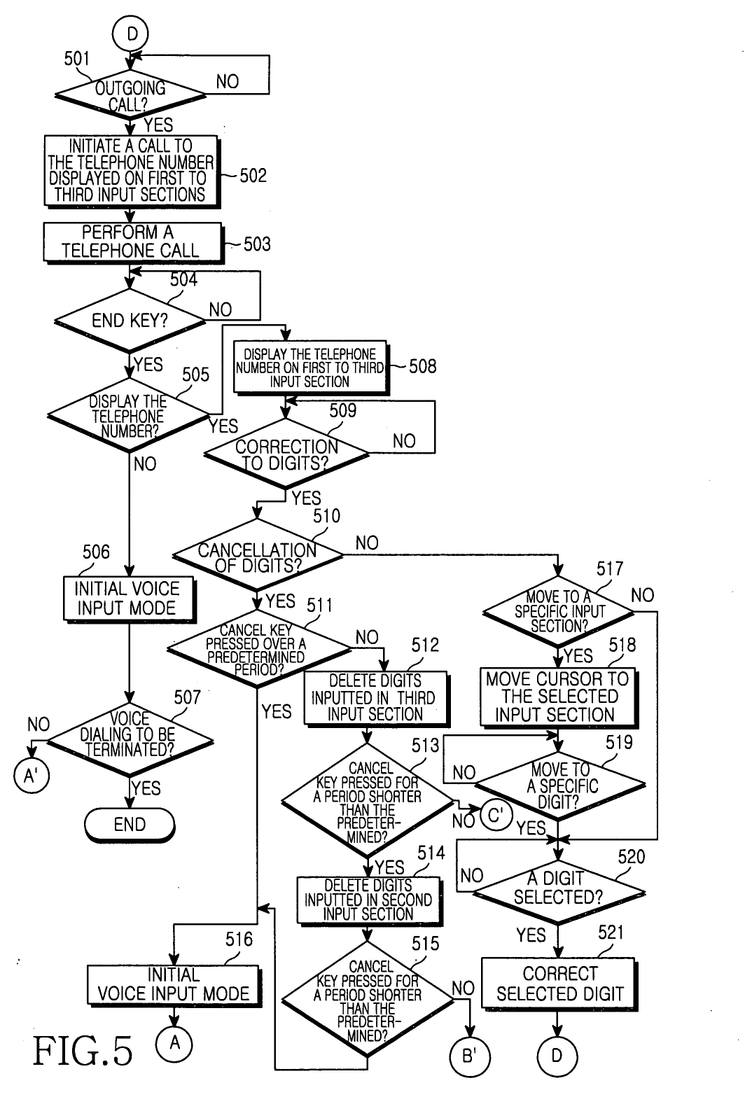

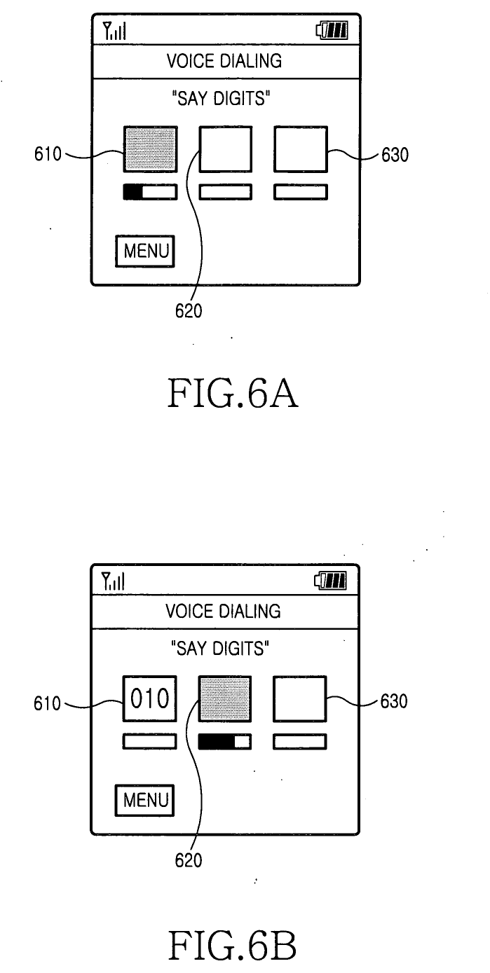

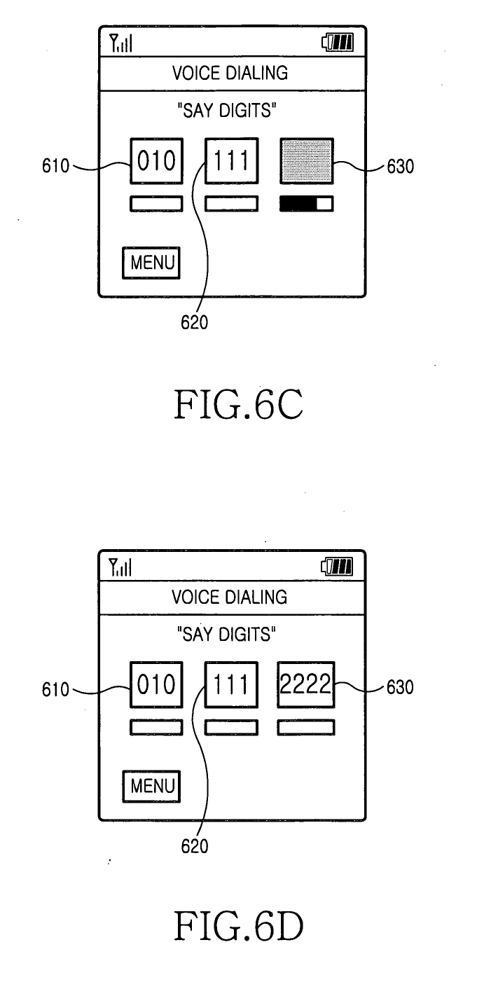

FIG. 2 is a flow chart showing a process for inputting digits in a first input section in a voice dialing mode of a mobile terminal according to an embodiment of the present invention. FIG. 3 is a flow chart showing a process for inputting digits in a second input section in a voice dialing mode of a mobile terminal according to an embodiment of the present invention. FIG. 4 is a flow chart showing a process of inputting digits in a third input section in a voice dialing mode of a mobile terminal according to an embodiment of the present invention. FIG. 5 is a flow chart showing a process of making a telephone call in a voice dialing mode of a mobile terminal according to an embodiment of the present invention. FIGS. 6A to 6D are views for explaining the processes in FIGS. 2 to 5. In an embodiment of the present invention, the voice dialing section consists of three blocks, i.e., a first to third input sections. Each block displays a series of digits inputted by voice as a code. More specifically, the first input section displays an area code or a service provider identification code, which is typically composed of three digits. The second input section displays a dialing code which is the former part of a telephone number. Typically, the dialing code is composed of three or four digits. The third input section displays a user calling code which is the latter part of a telephone number. It is supposed that the user calling code is composed of four digits. The number of digits inputted in each input section varies depending on the types of telephone numbers and each country's own telephone numbering system. In an embodiment of the present invention, digits are inputted by voice sequentially in the voice dialing section from the first input section to the third input section. However, it is also possible to select the second or third input section and input digits in the selected section first.

Hereinafter, the voice dialing method according to an embodiment of the present invention will be explained in more detail with reference to the accompanying drawings. Referring to FIG. 2, when the user selects a voice dialing function on the mobile terminal, the control section 110 detects the selection at step 200 and changes the current mode of the mobile terminal to an initial voice input mode at step 201. In the initial voice input mode, the display section 160 displays the voice dialing section consisting of the first to third input sections. FIG. 6A shows the display of the voice dialing section with three input sections in the initial voice input mode.

When the user selects the first input section 610 for voice dialing, the control section 110 detects the selection at step 202 and displays consecutive digits input by voice through the voice recognizer 170 in the first input section 610 at step 203. If the mobile terminal has been set to display digits inputted by voice in the voice dialing section in order from the first input section 610, the first input series of digits will be displayed automatically in the first input section 610, without the user's selection of the first input section. Upon completion of the input of digits representing an area code or a service provider identification code in the first input section, the control section 110 detects the completion at step 204 and checks the number of digits input in the first input section 610.

If four consecutive digits are inputted in the first input section 610, the control section 110 will determine that the four digits represent a user calling code at step 205 and will proceed with step 206 to display the four digits in the third input section 630. The control section 110 proceeds with step 207 to determines whether a telephone number with the same digits as displayed in the third input section 610 is present in a phonebook, preferably, within the mobile terminal. When a corresponding telephone number is present in the phonebook, the control section 110 detects the presence at step 208 and proceeds with step 209. At step 209, the control section 110 controls the display of an area code or a service provider identification code of the detected telephone number in the first input section 610 and a dialing code of the detected telephone number in the second input section 620, thereby displaying the complete telephone number in the first to third input section. On the other hand, when a telephone number not having the same digits as displayed in the third input section 630 is present in the phonebook, the control section 110 will detect the absence of the corresponding telephone number at step 208 and returns to the initial voice input mode of step 201 to input an area code or a service provider identification code in the first input section 610. If three consecutive digits are input in the first input section 610, the control section 110 will detect the input at step 205 and will determine whether the three digits input represent an area code or a service provider identification code included in a telephone code table stored in the memory 130. If the control section 110 detects that neither an area code nor a service provider identification code corresponding to the inputted digits is present in the telephone code table at step 211, it will then proceed with step 212 to display a message indicating an error or requesting re-input of digits. Since area codes and service provider identification codes that can be displayed in the first input section 610 have been predetermined to be used in the telephone numbers of specific areas or specific service users, the telephone code table listing the predetermined area codes and service provider identification codes can prevent any erroneous code inputs. If an area code or a service provider identification code corresponding to the three consecutive digits input is present in the telephone code table, the control section will detect the presence of the corresponding code at step 211 and will then control the correction of any digit erroneously inputted in the first input section or move the cursor to the second input section.

If four or more digits have been inputted in the first input section 610, the control section 110 will detect the number of the inputted digits and will display a message indicating an error or requesting re-input of digits. Upon completion of or during the input of an area code or a service provider identification code in the first input section 610, the user can select to correct an erroneous digit. The control section 110 detects the user's selection to correct at step 213 and displays the types of corrections. The control section 110 determines the type of correction according to the length of time during which a specific function key or a specific icon is inputted or to the user's voice command. When the user selects to move to a specific digit as the type of correction, the control section 110 detects the selection at step 214 and initiates a mode for moving the cursor within the first input section 610. In that mode, the user can move the cursor to a digit to be corrected in the first input section 610 by a voice command. Alternatively, the user can move the cursor using a direction key provided on the key input section 127. The control section 110 detects the selection of a digit to be corrected in the first input section 610 at step 215 and proceeds with step 216. At step 216, the user can say a new digit while the cursor is placed on the selected digit. The control section 110 then corrects the selected digit by replacing it with the new digit input by voice. Alternatively, the user can directly input the new digit using the corresponding number key on the key input section 127 so that the newly input digit can replace the digit with the cursor placed thereon.

When the user selects a cancel as the type of correction, the control section 110 detects the selection at step 217 and initiates a mode for canceling the input digits. In the cancel mode, the user can press a cancel key or just say “cancel.” Upon detecting the input of the cancel key or the voice command, the control section 110 deletes all digits input in the first input section 610 and returns to the initial voice input mode of step 201. FIG. 6B shows the display of the voice dialing section with an area code or a service provider identification code input in the first input section.

Referring to the flowchart of FIG. 3, upon completion of the input of an area code or a service provider identification code in the first input section 610, the second input section 620 will be selected by the user's key input or automatically. The control section 110 detects the selection of the second input section at step 301 and proceeds with step 302 to input a dialing code. The control section 110 detects the completion of the input of the dialing code in the second input section 620 at step 303 and determines whether the user selects a correction of the dialing code input in the second input section 620. The control section 110 detects a selection to correct the dialing code at step 304. If the user selects a correction during the input of the dialing code at step 302, the control section 110 will detect the selection to correct at step 305 and displays the types of corrections. The control section 110 determines the type of correction according to the length of time during which a specific function key or a specific icon is input or to the user's voice command. When the user selects a cancel as the type of correction, the control section 110 detects the selection at step 306 and initiates a mode for canceling the inputted digits. In the cancel mode, the user can press a cancel key. The control section 110 then determines whether the cancel key is pressed for a period equal to of longer than a predetermined period of time. If the cancel key is pressed for a period equal to or longer than the predetermined period, the control section 110 will detect the key input at step 307 and will proceed with step 310 to delete all the digits input in the first and second input sections 610 and 620 and return to the initial voice input mode as shown in FIG. 6A. If the cancel key is pressed for a period shorter than the predetermined period, the control section 110 will detect the key input at step 307 and will proceed with step 308 to delete the digits input in the second input section 620 and return to step 302. If the cancel key is pressed again for a period shorter than the predetermined period at step 308, the control section 110 will detect the key input at step 309 and will delete the digits input in the first input section 610 and return to the initial voice input mode of step 201 as shown in FIG. 6A. In the cancel mode, the user may cancel the codes input in both the first and second input sections or only the code input in the second input section by pressing the cancel key for a period equal to or longer than or shorter than the predetermined period or by inputting a voice command “cancel.” It is also possible to return to the initial voice input mode by just saying “to the beginning” or other similar phrase. Voice commands can be selectively changed by the user.

When the user selects a move to a specific input section as the type of correction, the control section 110 detects the selection at step 311 and initiates a mode for moving the cursor at step 312. In that mode, the user can move the cursor to a specific input section by a key input on the key input section 127 or a voice command. After moving the cursor to the specific input section, the user can select a move to a specific digit in that input section. The control section 110 detects the selection at step 313 and initiates a mode for moving the cursor to a specific digit in the specific input section. In that mode, the user can move the cursor to a digit to be corrected in the selected input section by a voice command or using a direction key provided on the key input section 127. When the user selects a digit to be corrected by placing the cursor on the digit, the control section 110 detects the selection at step 314 and proceeds with step 315. At step 315, the user can say a new digit while the cursor is placed on the selected digit. The control section 110 then corrects the selected digit by replacing it with the new digit input by voice. Alternatively, the user can directly input the new digit using the corresponding number key on the key input section 127 so that the newly input digit can replace the digit with the cursor placed thereon.

The user can directly select a move to a specific digit as the type of correction. The control section 110 detects such a selection at step 313 and initiates the mode for moving the cursor to a specific digit. The control section 110 proceeds with steps 314 and 315. At this time, the user can move the cursor to a digit to be corrected in any of the first to third input sections by a voice command or using a direction key provided on the key input section 127. FIG. 6C shows the display of the voice dialing section with codes input in the first and second input sections 610 and 620, respectively.

Referring to FIG. 4, upon completion of the input of a dialing code in the second input section 620, the third input section 630 will be selected by the user's key input or automatically. The control section 110 detects the selection of the third input section at step 401 and proceeds with step 402 to input a user calling code. The control section 110 detects the completion of the input of the user calling code in the third input section 630 at step 403 and proceeds with step 404 to determine whether codes have been input in the first and second input sections 610 and 620. If no code has been input in the first or second input section 610 or 620, the control section 110 will recognize that the user has selected the third input section 630 first in the initial voice input mode to input the user calling code first and will then search the phonebook at step 405 in order to determine whether a telephone number including the user calling code input in the third input section 630 is present in the phonebook. If a corresponding telephone number is present in the phonebook, the control section 110 will detect the presence at step 406 and will proceed with step 407. At step 407, the control section 110 controls the display of an area code or a service provider identification code of the detected telephone number in the first input section 610 and a dialing code of the detected telephone number in the second input section 620, thereby displaying the complete telephone number in the first to third input section. On the other hand, when no corresponding telephone number is present in the phonebook, the control section 110 will detect the absence of the corresponding telephone number at step 406 and returns to the initial voice input mode of step 201 to input an area code or a service provider identification code in the first input section 610.

If the user requests for a correction to a specific digit after or during the input of the user calling code in the third input section 630, the control section 110 will detect the request at step 408 and displays the types of corrections. The control section 110 determines the type of correction according to the input time of a specific function key or a specific icon or to the user's voice command. When the user selects a cancel as a type of correction, the control section 110 detect the selection at step 409 and initiates a mode for canceling the inputted digits. When the user presses a cancel key in the cancel mode, the control section 110 monitors the input time of the cancel key. If the cancel key is pressed for a period longer than a predetermined period of time, the control section 110 will detect the key input at step 410 and will delete all the digits input in the first to third input sections 610 to 630 and return to the initial voice input mode as shown in FIG. 6a. If the cancel key is pressed for a period of time shorter than the predetermined period, the control section 110 will detect the key input at step 410 and will proceed with step 411 to delete the digits input in the third input section 630 and return to step 402. If the cancel key is pressed again for a period of time shorter than the predetermined period at step 411, the control section 110 will detect the key input at step 412 and will proceed with step 413 to delete the digits input in the second input section 620 and return to step 302. If the cancel key is pressed once again for a period shorter than the predetermined period at step 413, the control section 110 will detect the key input at step 414 and will proceed with step 415 to delete the digits input in the first input section 610 and return to the initial voice input mode as shown in FIG. 6A.

When the user selects a move to a specific input section as a type of correction, the control section 110 detects the selection at step 416 and initiates a mode for moving the cursor at step 417. In that mode, the user can move the cursor to a specific input section by a key input on the key input section 127 or a voice command. After moving the cursor to the specific input section, the user can select to move the cursor to a specific digit in that input section. The control section 110 detects the selection at step 418 and initiates a mode for moving the cursor to a specific digit in the specific input section. In that mode, the user can move the cursor to a digit to be corrected in the selected input section by a voice command or using a direction key provided on the key input section 127. When the user selects a digit to be corrected by placing the cursor on the digit, the control section 110 detects the selection at step 419 and proceeds with step 420. At step 420, the user can say a new digit while the cursor is placed on the selected digit. The control section 110 then corrects the selected digit by replacing it with the new digit input by voice. Alternatively, the user can directly input the new digit using the corresponding number key on the key input section 127 so that the newly input digit can replace the digit which has the cursor placed thereon.

The user can directly select a move to a specific digit as the type of correction. The control section 110 detects such a selection at step 418 and initiates the mode for moving the cursor to a specific digit. The control section 110 proceeds with steps 419 and 420. At this time, the user can move the cursor to a digit to be corrected in any of the first to third input sections by a voice command or using a direction key provided on the key input section 127. FIG. 6D shows the display of the voice dialing section with codes input in the first to third input sections 610 to 630.

Hereinafter, a process of making a call to a telephone number input in the first to third input sections as shown in FIGS. 2 through 4 will be explained in ore detail with reference to FIG. 5. Referring to FIG. 5, the user can press a send key or input a corresponding voice command. The control section 110 detects the input of the send key or the voice command at step 501 and proceeds with step 502 to initiate an outgoing call to the telephone number displayed in the first to third input sections. When the user presses an end key to terminate the call at step 503, the control section 110 detects the end key input at step 504 and terminates the call function. Then the control section 110 controls the display section 160 to display a message asking whether the telephone number should be displayed again. If the user selects “no,” the control section 110 will detect the selection at step 505 and will proceed with step 506 to enter the initial voice input mode. At this time, the user may cancel the voice dialing mode. Upon detecting the cancellation of the voice dialing mode at step 507, the control section 110 terminates the voice dialing mode. If the user selects “yes” to display the telephone number, the control section 110 will detect the selection at step 505 and will proceed with step 508 to display the telephone number in the first to third input sections 610 to 630 as shown in FIG. 6D.

At step 508, the user can select a correction to a specific digit. The control section 110 detects such a selection at step 509 and displays the types of corrections. The control section 110 determines the type of correction according to the input time of a specific function key or a specific icon or to the user's voice command. When the user selects a cancel as the type of correction, the control section 110 detect the selection at step 510 and initiates a mode for canceling the input digits. When the user presses a cancel key in the cancel mode, the control section 110 monitors the input time of the cancel key. If the cancel key is pressed for a period equal to or longer than a predetermined period of time, the control section 110 will detect the key input at step 511 and will delete all the digits input in the first to third input sections 610 to 630 and return to the initial voice input mode as shown in FIG. 6A. If the cancel key is pressed for a period of time shorter than the predetermined period, the control section 110 will detect the key input at step 511 and will proceed with step 512 to delete the digits input in the third input section 630 and return to step 402. If the cancel key is pressed again for a period of time shorter than the predetermined period at step 512, the control section 110 will detect the key input at step 513 and will proceed with step 514 to delete the digits input in the second input section 620 and return to step 302. If the cancel key is pressed once again for a period shorter than the predetermined period at step 514, the control section 110 will detect the key input at step 515 and will proceed with step 516 to delete the digits input in the first input section 610 and return to the initial voice input mode as shown in FIG. 6A.

When the user selects a move to a specific input section as the type of correction, the control section 110 detects the selection at step 517 and initiates a mode for moving the cursor. In that mode, the user can move the cursor to a specific input section by a key input on the key input section 127 or a voice command. After moving the cursor to the specific input section at step 518, the user can select a move to a specific digit in that input section. The control section 110 detects the selection at step 519 and initiates a mode for moving the cursor to a specific digit in the specific input section. In that mode, the user can move the cursor to a digit to be corrected in the selected input section by a voice command or using a direction key provided on the key input section 127. When the user selects a digit to be corrected by placing the cursor on the digit, the control section 110 detects the selection at step 520 and proceeds with step 521. At step 521, the user can say a new digit while the cursor is placed on the selected digit. The control section 110 then corrects the selected digit by replacing it with the new digit input by voice. Alternatively, the user can directly input the new digit using the corresponding number key on the key input section 127 so that the newly input digit can replace the digit with the cursor placed thereon.

The user can directly select a move to a specific digit as the type of correction. The control section 110 detects such a selection at step 519 and initiates the mode for moving the cursor to a specific digit. The control section 110 proceeds with steps 520 and 521. At this time, the user can move the cursor to a digit to be corrected in any of the first to third input sections by a voice command or using a direction key provided on the key input section 127.

After making an outgoing call to a telephone number, the user can display the telephone number and correct some digits in the telephone number to make another outgoing call to a similar telephone number having the same area code, service provider identification code or dialing code as included in the previous telephone number, without the need to input all the digits of the next telephone number.

The embodiments of the present invention enable voice-activated dialing of a telephone number on a mobile terminal, eliminating the need to directly press number keys.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for voice-activated dialing of a telephone number on a mobile terminal, which comprises the steps of:
when voice dialing is selected, entering an initial voice input mode to display a voice dialing section consisting of a plurality of consecutive digit input sections;
displaying consecutive digits input by voice on the plurality of input sections of the voice dialing section in the initial voice input mode; and
when a send key is input, making an outgoing call to a telephone number consisting of the digits displayed on the voice dialing section.

2. The method as claimed in claim 1, wherein said digits inputted by voice are displayed on the input sections in the order of arrangement in the voice dialing section.

3. The method as claimed in claim 1, wherein said input sections of the voice dialing section are assigned to display respective codes of a telephone number.

4. The method as claimed in claim 3, wherein the displayed respective code of a telephone number consist of a code selected from the group of an area code, a city code, a service provider identification code and a user's calling code as classified according to each country's telephone numbering system.

5. The method as claimed in claim 1, wherein said voice dialing section consists of first to third input sections, three digits input by voice being displayable on the first input section, three or four digits input by voice being displayable on the second input section, and four digits input by voice being displayable on the third input section.

6. The method as claimed in claim 1, wherein said voice dialing section consists of first to third input sections, three digits input by voice being displayable on the first input section, five digits input by voice being displayable on the second input section, and three digits input by voice being displayable on the third input section.

7. The method as claimed in claim 1, wherein said voice dialing section consists of first to fourth input sections, two digits input by voice being displayable on each of the first to fourth input sections.

8. The method as claimed in claim 1, wherein said step of displaying digits input by voice on the voice dialing section comprises the steps of:
displaying digits input by voice in a first input section;
upon completion of the input of digits in the first input section, moving a cursor to a second input section; and
repeating display of input digits and move to a next input section until digits are sequentially input in every input section of the voice dialing section.

9. The method as claimed in claim 1, wherein said step of displaying digits input by voice on the voice dialing section comprises the steps of:
selecting one of the plurality of input sections;
displaying digits input by voice on the selected input section; and
repeating said selection and display until a complete telephone number is input in the voice dialing section.

10. The method as claimed in claim 8, wherein said step of displaying digits input by voice on a first input section comprises the steps of:
displaying digits input by voice on the first input section;
comparing the input digits with codes stored in a telephone code table;
when a code corresponding to the input digits is present in the telephone code table, moving the cursor to a next input section; and
when no corresponding code is present in the telephone code table, displaying a message indicating an error or requesting re-input of digits.

11. The method as claimed in claim 10, wherein said telephone code table stores specific codes that can be displayed on said first input section.

12. The method as claimed in claim 8, further comprising the steps of:
determining whether a telephone number with the digits input in said first input section is present in a phonebook storing telephone numbers;
when a corresponding telephone number is detected in the phonebook, displaying the detected telephone number; and
when no corresponding telephone number is detected, moving the cursor to the next input section to input new digits by voice.

13. The method as claimed in claim 1, further comprising the steps of:
when a correction to the digits displayed on the voice dialing section is selected, determining a type of correction according to the user's input;
when a move to a specific digit in a specific input section is selected as the type of correction, moving a cursor to the specific digit and correcting the digit;
when cancellation of input digits is selected as the type of correction, deleting digits input in said specific input section and inputting new digits by voice, or deleting digits input in every input section and returning to the initial oice input mode to input new digits by voice sequentially in the voice dialing section in order from the first input section; and
when a move to a specific input section is selected as the type of correction, moving the cursor to the selected input section, deleting digits input in the selected input section, inputting new digits in the same input section and waiting for next input of digits.

14. The method as claimed in claim 13, wherein said user's input includes input of a specific function key, specific icon or user's voice command and the type of correction is determined according to the length of time during which the specific function key or icon is input and to the user's voice command.

15. A method for voice-activated dialing of a telephone number on a mobile terminal, which comprises the steps of:
when voice dialing is selected, entering an initial voice input mode to display a voice dialing section consisting of first to third input sections for voice dialing;
displaying consecutive digits input by voice on the input sections in the initial voice input mode; and
when a send key is input, making an outgoing call to a telephone number consisting of the digits displayed on the voice dialing section.

16. The method as claimed in claim 15, wherein the digits input by voice are displayed sequentially in the voice dialing section from the first input section to the third input section.

17. The method as claimed in claim 15, wherein said first input section displays an area code or a service provider identification code, said second input section displays a dialing code which is the former part of a telephone number, and said third input section displays a user calling code which is the latter part of a telephone number.

18. The method as claimed in claim 15, wherein said step of displaying digits input by voice on the input sections comprises the steps of:
displaying digits input by voice on the first input section;
upon completion of the input of digits in the first input section, moving a cursor to the second input section;
displaying digits input by voice on the second input section;
upon completion of the input of digits in the second input section, moving the cursor to the third input section; and
displaying digits input by voice on the third input section.

19. The method as claimed in claim 15, wherein said step of displaying digits input by voice on the input sections comprises the steps of:
selecting one of the first to third input sections;
displaying digits input by voice on the selected input section; and
repeating selection of an input section and display of digits until a complete telephone number is displayed on the voice dialing section.

20. The method as claimed in claim 18, wherein said display of digits input by voice on the first input section comprises the steps of:
displaying digits input by voice on the first input section;
comparing the input digits with codes stored in a telephone code table;
when a code corresponding to the input digits is present in the telephone code table, moving the cursor to the second input section; and
when no corresponding code is present in the telephone code table, displaying a message indicating an error or requesting re-input of digits.

21. The method as claimed in claim 20, wherein said telephone code table stores specific codes that can be displayed on said first input section.

22. The method as claimed in claim 20, further comprising the steps of:
when digits displayable on the third input section are input in the first input section, displaying the digits in the third input section;
determining whether a telephone number with the digits input in the third input section is present in a phonebook storing telephone numbers;
when a corresponding telephone number is detected in the phonebook, displaying the detected telephone number on the first to third input sections; and
when no corresponding telephone number is detected, moving the cursor to the first input section.

23. The method as claimed in claim 20, further comprising the steps of:
when a correction to the digits displayed on the first input section is selected, displaying types of corrections;
when a move to a specific digit is selected as a type of correction, moving the cursor to select an erroneous digit and correcting the selected digit; and
when cancellation of digits is selected as a type of correction, deleting all the digits displayed on the first input section and returning to the initial voice input mode.

24. The method as claimed in claim 18, wherein said display of digits input by voice on the second input section comprising the steps of:
displaying digits input by voice on the second input section;
when a correction to the digits displayed on the second input section is selected, displaying types of corrections;
when a move to a specific digit is selected as a type of correction, moving the cursor to select an erroneous digit in the second input section and correcting the selected digit;
when a move to a specific input section is selected as a type of correction, moving the cursor to a selected one of the first and second input sections;
when a move to a specific digit in the selected input section is selected, selecting an erroneous digit in the selected input section and correcting the selected digit;
when cancellation of digits is selected as a type of correction, determining whether a cancel key is pressed for a period longer than a predetermined period of time;
when the cancel key is pressed for a period equal to or longer than the predetermined period, deleting all the digits displayed on the first and second input sections and returning to the initial voice input mode;
when the cancel key is pressed for a period shorter than the predetermined period, deleting the digits displayed on the second input section; and
when the cancel key is pressed again for a period shorter than the predetermined period, deleting the digits displayed on the first input section and returning to the initial voice input mode.

25. The method as claimed in claim 18, wherein said display of digits input by voice on the third input section comprises the steps of:
displaying digits input by voice on the third input section;
when a correction to the digits displayed on the third input section is selected, displaying types of corrections;
when a move to a specific digit is selected as a type of correction, moving the cursor to select an erroneous digit in the third input section and correcting the selected digit;
when a move to a specific input section is selected as a type of correction, moving the cursor to a selected one of the first to third input sections;
when a move to a specific digit in the selected input section is selected, selecting an erroneous digit in the selected input section and correcting the selected digit;
when cancellation of digits is selected as a type of correction, determining whether a cancel key is pressed for a period equal to or longer than a predetermined period of time;
when the cancel key is pressed for a period equal to or longer than the predetermined period, deleting all the digits displayed on the first to third input sections and returning to the initial voice input mode;
when the cancel key is pressed for a period shorter than the predetermined period, deleting the digits displayed on the third input section;
when the cancel key is pressed again for a period shorter than the predetermined period, deleting the digits displayed on the second input section; and
when the cancel key is pressed once again for a period shorter than the predetermined period, deleting the digits displayed on the first input section and returning to the initial voice input mode.

26. The method as claimed in claim 25, further comprising the steps of:
when digits are displayed only on the third input section;
determining whether a telephone number with the digits input in the third input section is present in a phonebook storing telephone numbers;
when a corresponding telephone number is detected in the phonebook, displaying the detected telephone number on the first to third input sections; and
when no corresponding telephone number is detected, moving the cursor to the first input section.

27. The method as claimed in claim 15, further comprising the steps of:
displaying said telephone number dialed to make an outgoing call is displayed on the voice dialing section;
when a correction to said telephone number is selected, displaying types of corrections;
when a move to a specific digit is selected as a type of correction, selecting a digit displayed on any of the input sections and correcting the selected digit;
when a move to a specific input section is selected as a type of correction, moving the cursor to a selected one of the first to third input sections;
when a move to a specific digit in the selected input section is selected, selecting a digit in the selected input section and correcting the selected digit;
when cancellation of digits is selected as a type of correction, determining whether a cancel key is pressed for a period equal to or longer than a predetermined period of time;
when the cancel key is pressed for a period equal to or longer than the predetermined period, deleting all the digits displayed on the first to third input sections and returning to the initial voice input mode;
when the cancel key is pressed for a period shorter than the predetermined period, deleting the digits displayed on the third input section;
when the cancel key is pressed again for a period shorter than the predetermined period, deleting the digits displayed on the second input section; and
when the cancel key is pressed once again for a period shorter than the predetermined period, deleting the digits displayed on the first input section and returning to the initial voice input mode.

28. A method for voice-activated dialing of a telephone number on a mobile terminal, which comprises the steps of:
when voice dialing is selected, entering an initial voice input mode to display a voice dialing section consisting of first to three input sections for voice dialing;
displaying consecutive digits input by voice on the first input section in the initial voice input mode;
selecting any incorrect one of the digits displayed on the first input section and correcting the selected digit;
upon completion of the input of digits in the first input section, moving a cursor to the second input section;
displaying consecutive digits input by voice on the second input section;
moving the cursor to select any incorrect one of the digits displayed on the first and second input sections and correcting the selected digit;
upon completion of the input of digits in the second input section, moving the cursor to the third input section;
displaying consecutive digits input by voice on the third input section;
moving the cursor to select any incorrect one of the digits displayed on the first to third input sections and correcting the selected digit; and
upon completion of the input of digits in the third input section, making an outgoing call to a telephone number consisting of the digits displayed on the voice dialing section.
